(19) United States
(12) Patent Application Publication
(10) Pub. No.: US 2003/0163541 A1
(43) Pub. Date: Aug. 28, 2003

(54) System and method for distributing information

(76) Inventors: James F. Austin, Indianapolis, IN (US); Bradley J. Graves, Noblesville, IN (US); Miles D. Rincker, Indianapolis, IN (US)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/082,578

(22) Filed: Feb. 25, 2002

(51) Int. Cl. G06F 15/16

(52) U.S. Cl. 709/207; 709/213; 709/224

(57) ABSTRACT

A system and method for distributing information during an event among a plurality of participants of the event includes a plurality of wireless devices (12a-12x) for wirelessly communicating with a server (16) via a network (14). The wireless devices (12a-12x) are individually associated with the plurality of participants. Each wireless device (12a-12x) includes application software (28) for enabling an associated participant to periodically store individual information in the wireless device (12a-12x) during the event. The network (14) includes a transceiver (13) adapted to receive individual information from and provide event information to the wireless devices (12a-12x). The server (16) includes server software (30) to enable the server (16) to receive individual information from the transceiver (13), compute the event information based on the received individual information, and transmit the event information to the transceiver (13) for substantially real-time wireless distribution to the participants via the wireless devices (12a-12x). The application software (28) continues to enable storage of individual information when a wireless device (12a-12x) is outside a range of communication with the transceiver (13).

### FIELD OF THE INVENTION

The present invention relates generally to a system and method for distributing information among participants in an event, and more particularly to a web-based system for wirelessly communicating, in substantially real-time, information to participants in an event relating to the activities of the participants during the event.

### BACKGROUND OF THE INVENTION

Many different types of events include a plurality of participants who perform activities simultaneously, but in different locations. As the participants perform these activities, each participant, or group of participants, generally generates information relating to or describing the participant's recently performed activities. During marketing research, for example, a plurality of researchers may simultaneously cover different geographic territories, collecting marketing information as they cover their area. In a voting situation, poll operators at separate locations simultaneously accumulate voting information during a voting event.

In other circumstances the event is competitive, such as an athletic event, wherein the information generated by the participants of the event relates to or describes the performance of the participants as the participants progress toward the end of the event. In a fishing contest, for example, the performance of a participant may be measured or described by the number and/or size of the fish caught by the participant. In a golf tournament, the performance of the participant may be described by the score of the participant for each hole in a round of golf.

Sharing of the above-described information among the participants during the event is desirable for a variety of reasons. In non-competitive, information gathering events, trends in the information may be identified early in the event, thereby possibly influencing the remainder of the event. In competitive events, the performance of one participant relative to the other participants may be used by the participant to adjust subsequent performance. For example, during a golf tournament, a participant may play more aggressive golf during the remainder of a tournament if the participant is aware that the other participants are presently outplaying the participant.

Some systems for tracking information during an event merely permit the collection of the individual information of participants during the event. At the end of the event, the information is compiled and distributed among the participants. Clearly, such systems do not permit mid-event adjustments in either the way the event is conducted or the performance of the participants. Other systems permit the sharing of information during the event by utilizing wireless technology that permits the participants to upload individual information to a central location and download information relating to other participants from the central location. These systems are deficient, however, because they require continuous communication with the central location. When, for example, an individual wireless device is out of range for communication with the central location, the participant is prevented not only from uploading and downloading information, but also from continuing to compile the participant's individual information.

### SUMMARY OF THE INVENTION

The present invention provides a system and method for distributing information during an event among a plurality of participants in the event. The system generally includes a plurality of wireless devices for wirelessly communicating with a server on a network via a transceiver coupled to the network. Each wireless device includes application software for enabling the associated participant to periodically store individual information in the wireless device during the event and wirelessly transmit the information to the transceiver. The transceiver is adapted to receive individual information from and provide event information (i.e., a compilation of the received individual information) to the wireless devices. The server includes server software to enable the server to receive individual information from the transceiver, compute or compile the event information based on the received individual information, and transmit the event information to the transceiver for wireless distribution to the participants via the wireless devices.

In one embodiment of the invention, the application software continues to enable storage of the individual information when the wireless device operating the application software is outside a range of communication of the transceiver. In another embodiment of the invention, the application software permits downloading of advertising material from the network and storage of a portion of the advertising material on the wireless devices such that that portion of advertising material may be viewed by a participant even when the participant's wireless device is outside the range of the transceiver.

The features of the present invention described above, as well as additional features, will be readily apparent to those skilled in the art upon reference to the following description and the accompanying drawings.

### BRIEF DESCRIPTION OF THE DRAWINGS

FIG. 1 is a conceptual diagram of an information distribution system according to one embodiment of the present invention.

FIGS. 2-11 are screen shots of various screens generated on a wireless device by software according to embodiments of the present invention.

### DESCRIPTION OF EMBODIMENTS OF THE INVENTION

The embodiments described below are merely exemplary and are not intended to limit the invention to the precise forms disclosed. Instead, the embodiments were selected for description to enable one of ordinary skill in the art to practice the invention.

A system and method according to the present invention may find application in a variety of different environments. Marketing, voting, fishing, and golfing environments are mentioned above. For purposes of example only, and to simplify the description of embodiments of the invention, the following description relates to a golfing environment. More specifically, the various features of the present invention are described below as adapted to provide substantially real-time, wireless distribution of golf score data over a network among participants in a golfing event.

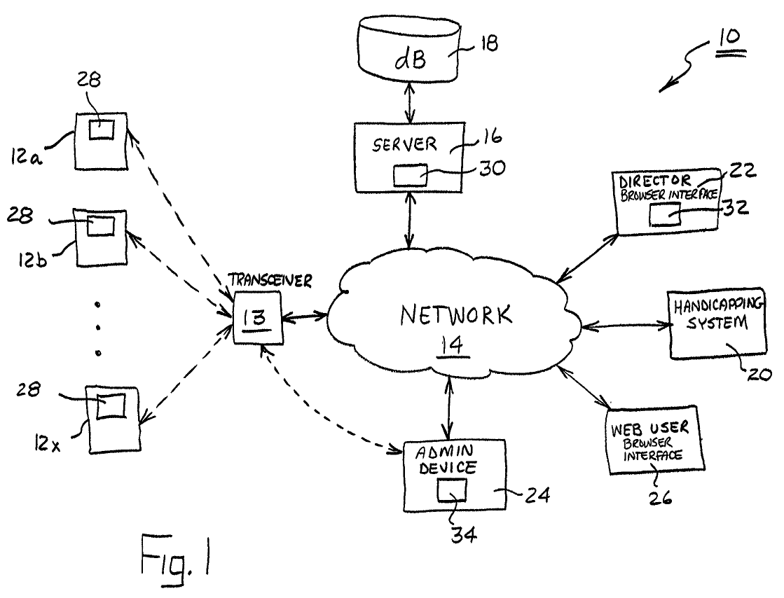

Referring now to FIG. 1, a system 10 according to one embodiment of the present invention generally includes a plurality of wireless devices 12a-12x (only three shown), a transceiver 13, a network 14, a server 16, a database 18, a handicapping system 20, a director browser interface 22, an administrator device 24, and a web user browser interface 26. A variety of different personal digital assistants (PDAs) or other similar devices may be employed as wireless devices 12a-12x, such as, for example, Palm® VIlx, Palm® i705, or other Palm® devices including CDPD modems. Wireless devices 12a-12x communicate with transceiver 13 using conventional wireless communication technology. Transceiver 13 is coupled via network 14 to server 16. Network 14 may be, for example, the internet in conjunction with radio and cellular networks. Server 16 may be implemented using, for example, an Intel x86-based workstation or similar device. As shown in FIG. 1, server 16 is connected to database 18 which contains various types of information for distribution and storage as further described below. Director browser interface 22 may be implemented using a standard personal computer (PC) or other similar web interface connected to network 14 via a conventional modem (not shown). Administrator device 24, like wireless devices 12a-12x, may be implemented as any one of a variety of conventional PDAs. Administrator device 24 may communicate with server 16 via network 14 using either wireless communication technology or via a conventional “cradle” (not shown) coupled to network 14 via a PC and modem (not shown). Web user browser interface 26 may be either a standard PC or a conventional PDA. Handicapping system 20 may be, for example, the USGA handicapping system, a web site on the internet that provides handicap calculation based on inputted golf scores as is further described below.

A program for use with a system as shown in FIG. 1 may include a variety of separate software components. In addition to the various operating systems and communications software included in the hardware components shown in FIG. 1, wireless devices 12a-12x include application software 28, server 16 includes server software 30, director browser interface 22 includes director software 32, and administrator device 24 includes administrator software 34. Each of the various software components enables the corresponding hardware component to perform certain functions. In order to provide context for a description of those functions, an example of a golf tournament event is described below.

A tournament organizer or director may set up a tournament by accessing a web site (not shown) operated by server 16 on network 14. The web site is commerce enabled in a manner known to those skilled in the art to permit payment of a fee in exchange for the service provided by the system shown in FIG. 1. At this time, the tournament director may provide a course description including an identifier recognized by handicapping system 20, and other information including course slope, hole par values, course rating, hole yardage, etc. Alternatively, the tournament director may select from predefined courses stored in database 18. The tournament director may then select tournament parameters provided by server software 30 including the type of golf game that will be played, the number of teams (if team play is specified), the number of players on each team, and the availability of tournament scoring information to non-participants. In addition, the tournament director can specify contest holes such as a longest drive hole, a closest-to-the-pin hole, a longest putt hole, and a hole-in-one hole. As is customary in golf tournaments, prizes may be associated with the winners of the contests associated with the various contest holes. The contest hole information, along with the other information defined by the tournament director is stored on server 16. The tournament director can also select from available local and national advertisements to be displayed on wireless devices 12a-12x during the tournament. This advertising material may be organized such that certain advertisers sponsor certain holes, while other advertising materials are periodically or episodically displayed or associated with the entire tournament as further described below.

Referring again to FIG. 1, administrator device 24, operating administrator software 34 which is also loaded prior to the tournament, may be used to effect changes in the tournament configuration just before the tournament begins or during the tournament. Administrator device 24 may be carried, for example, by a tournament official onto the course to ensure that the tournament is properly configured for the participants. For example, administrator software 34 permits a user of administrator device 24 to change the selection of contest holes, add or remove teams from the previously configured team definition, add or remove players from a particular team, and change team or participant scores to correct mistakes. These changes or additions may be wirelessly communicated to server 16 via transceiver 13 and network 14 so that server software 30 can make corresponding changes to the information stored in database 18. Alternatively, administrator device 24 may be placed in a PDA “cradle” connected to a standard PC configured for access to network 14 (and server 16).

Prior to the tournament, the participants are instructed to bring wireless devices 12a-12x for use during the tournament. Alternatively, wireless devices 12a-12x may be provided to the participants by the tournament organizer or sponsors for use during the tournament. Application software 28 is loaded on the respective wireless devices 12a-12x. Since each participant was previously defined by the tournament director using director browser interface 22, server software 30 may interface via network 14 with handicapping system 20 to determine the present handicap of the participants in the tournament. If a participant does not have a corresponding handicap stored in handicapping system 20, server software 30 indicates to director browser interface 22 during setup of the tournament that a present handicap for a particular participant must be provided. The tournament director provides that information prior to the beginning of the tournament.

In another embodiment of the invention, participants operating application software 28 on wireless devices 12a-12x and users of web user browser interface 26 operating conventional web browser software can access a web site controlled by server 16 to directly input golf score data after any round of golf on a course recognized by handicapping system 20. The golf score data is transferred from server 16 to handicapping system 20 where an updated handicap is calculated. The updated handicap may then be transferred to server 16 which may send an e-mail message to the participant or user who provided the golf score data. The e-mail message may include the updated handicap of the participant or user. Server 16 may also maintain a listing of updated handicaps of participants and users to be viewed on the web site controlled by server 16.

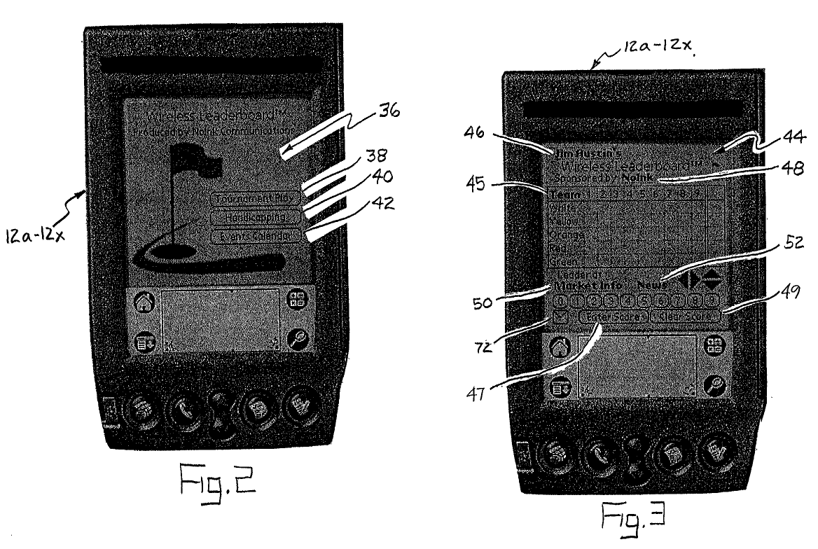

During play, each participant, or a representative participant from each team, carries a wireless device 12a-12x. Application software 28 initially generates an introduction screen 36 as shown in FIG. 2. From introduction screen 36, a participant may select tournament play by activating Tournament Play button 38, handicapping calculation as described above by activating Handicapping Button 40, or event calendar viewing (as described below) by activating Events Calendar Button 42. Assuming the participant activates Tournament Play button 38, application software 28 generates a main screen (scoring screen 44) as shown in FIG. 3 that includes an electronic leaderboard 45 that resembles a traditional golf scorecard. At the end of each hole, the participant taps one of the score buttons 0-9 at the lower portion of screen 44 to indicate the score of the participant or the team, depending upon the type of play. This golf score data (or individual information) is stored in the memory (not shown) of wireless device 12a-12x when the participant taps the Enter Score button 47. The Clear Score button 49 may be tapped to correct a mistakenly entered score. When the golf score data is entered, application software 28 enables wireless device 12a-12x to upload the golf score data to server 16 via transceiver 13 and network 14.

If a particular wireless device 12a-12x is not within a range of reception of transceiver 13 (for example, a portion of the golf course is too far from transceiver 13 to establish wireless communication), application software 28 simply delays transmission of the golf score data until wireless communications are again established. The golf score data is time-stamped by application software 28 when inputted into wireless device 12a-12x. Since the data is time-stamped, server 16 can determine, after a wireless device 12a-12x has been out of communication for a period of time, which (if any) of the golf score data subsequently transmitted should be added to the data stored in database 18. In one embodiment of the invention, server 16 may discontinue communications with a particular wireless device 12a-12x if, after a predetermined period of time, or a predetermined number of holes, the participant operating wireless device 12a-12x fails to input and upload a score. In this way, the system of FIG. 1 encourages information sharing during the event.

As participants upload golf score data to server 16, server 16 computes event information based on the golf score data. In this example, the event information is the leaderboard 45 shown on screen 44 of FIG. 3 which lists the various participants or teams in order of their current score (best score at the top). Of course, the event information could be displayed in a variety of different formats equally suitable for expressing the relative performance of the participants. This event information is transmitted to transceiver 13 substantially immediately after it is calculated (e.g., immediately after each participant or team uploads golf score data to server 16). The event information is then distributed to wireless devices 12a-12x by transceiver 13.

In a similar manner, participants may input contest hole information (i.e., the distance of a participant's drive on the longest drive hole, etc.) for uploading to server 16. Specifically, application software 28 may be configured to generate a pop-up message (not shown) after a hole immediately preceding a contest hole. The message may include a reminder that the next hole is a contest hole of a particular type, as well as an episodic advertisement such as who is sponsoring the contest hole. If, for example, the contest hole is a longest drive hole, the message may include an Input Drive Distance button (not shown) to enable the participant to input the participant's drive distance by, for example, selecting a distance from a list of distances provided in a pop-up menu. When the distance is entered, application software 28 enables wireless device 12a-12x to upload the contest hole information via transceiver 13 and network 14 to server 16. Server software 30 uses the contest hole information from individual participants (or teams) to update contest hole information stored in database 18. If a participant's contest hole information indicates that the participant is the new contest hole leader, server software 30 may enable server 16 to transmit a message via network 14 and transceiver 13 to all of the participants' wireless devices 12a-12x. The message may be displayed as a pop-up message, immediately notifying the participants when a new contest hole leader has been identified. Server software 30 may also provide a listing of contest hole leaders (or all contest hole information) on the web site controlled by server 16 for viewing by the participants or authorized users.

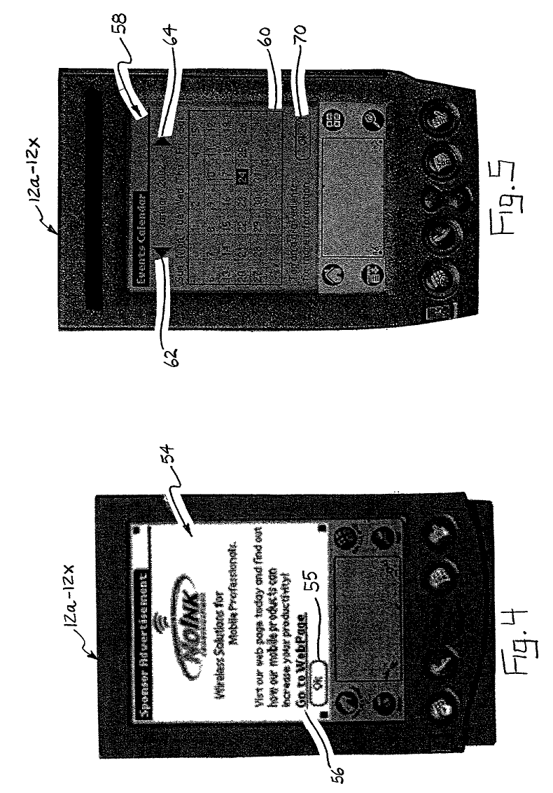

Also shown on FIG. 3 are advertiser links 46, 48, a financial information link 50 and news information link 52. If the wireless device 12a-12x is within communication range of transceiver 13, when a participant activates one of links 50, 52, the participant views, using conventional web browser technology, website information on network 14 associated with the selected link. In one embodiment of the invention, application software 28 generates another screen 54 (without communicating with network 14) in response to selection of one of the advertiser links 46, 48. Screen 54 (shown in FIG. 4) includes a portion of advertising material (associated with the advertiser of the selected link 46, 48) that is resident or stored in the memory of wireless device 12a-12x. By storing this advertising material in the memory of wireless device 12a-12x, the system of the present invention permits viewing of the resident advertising material even when wireless device 12a-12x is outside the range of communication of transceiver 13. Screen 54 of FIG. 4 may also includes a web site link 56 which the participant may tap to obtain further information regarding the advertiser, assuming wireless communication with transceiver 13 is possible. The participant may return to scoring screen 44 (FIG. 3) by tapping the OK button 55 on screen 54.

It should be understood that application software 28 may be configured such that the advertising materials depicted in FIGS. 3 and 4 may change periodically or episodically. For example, application software 28 may be configured to change advertiser links 46, 48 after each hole. Episodic advertising material may be displayed after a particular hole is completed, or after a predetermined number of holes are completed. Additionally, the presentation of the advertising material may be configured such that certain advertisers are associated with contest holes or other predetermined events during play. Of course, the second layer of resident advertising material included on screen 54 (FIG. 4) may be configured to correspond to the changes in advertising material displayed on scoring screen 44 of FIG. 3. Accordingly, as a participant progresses through a golf tournament, a variety of different types of advertising material are presented to the participant in a manner that corresponds to the sequence of holes of the round of golf or other events that occur during the round.

According to an alternate embodiment of the invention, application software 28 permits participants of an event to enter an e-mail address into wireless device 12a-12x for submission to server 16 via transceiver 13 and network 14 to obtain additional information related to a selected advertiser featured in the advertising material. Additionally, an option may be provided by application software 28 for creating an icon corresponding to a selected advertiser via the operating system of wireless device 12a-12x . For example, application software 28 may be configured such that when a user taps an advertiser link 46, 48, a pop-up message is displayed providing the participant with an option of creating an icon (i.e., embedding an advertisement) for display on a main operating screen of wireless device 12a-12x, the icon being linked to the selected advertiser's web site.

Web user browser interface 26 may also be used to access the web site controlled by server 16 on network 14 for viewing the event information or leaderboard 45 illustrated in FIG. 3. As indicated above, the tournament director may use director browser interface 22 to select whether the event information is public or private. If the information is public, the user of web user browser interface 26 can view the event information, and associated advertising, in substantially real-time without having to provide a password and identification number to log in to the web site. If web user browser interface 26 is a PDA, the user may carry web user browser interface 26 onto the course being played during the event. Thus, the user of web user browser interface 26 may observe the tournament and obtain substantially continuously updated scoring information of all of the participants. If a tournament is designated private, only users having the proper access information may log in to the web site and view the event information.

Additionally, a variety of types of historical information relating to prior tournaments or events may be accessed through the appropriate navigation of the web site by the user or a participant using a wireless device 12a-12x. The web site may also include a calendar of events stored in database 18. As indicated above, the calendar of events may be viewed by a participant operating application software 28 by activating Events Calendar button 42 (FIG. 2). As shown in FIG. 5, the first level screen 58 of Events Calendar information includes a one month calendar 60 that may be scrolled forward or backward by tapping scrolling arrows 62, 64. A day containing an event may be darkened or otherwise marked (such as the Jan. 24^{th}, 2002 shown on screen 58). By tapping an event day, application software 28 enables wireless device 12a-12x to communicate a request for further information regarding the event to server 16 and server software 30 over network 14.

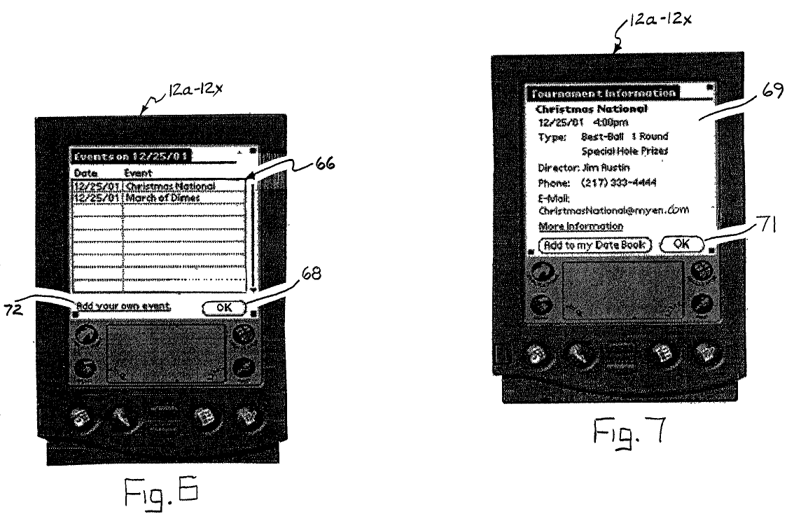

Server software 30 enables server 16 to obtain additional information (if any) contained in database 18 regarding the selected event day. This additional information is transmitted by server 16 via network 14 and transceiver 13 to wireless device 12a-12x, and is displayed by application software 28 as an information screen 66 as shown in FIG. 6. If more than one event occurs on a particular day as shown in FIG. 6, the user or participant may tap the desired event, thereby bringing up another, more detailed screen 69 including information regarding the selected event as shown in FIG. 7. The web user or participant may exit screen 69 by tapping OK button 71, thereby returning to information screen 66 of FIG. 6. Screen 66 is similarly exited by tapping OK button 68, thereby returning to screen 58. Finally, the user or participant may exit screen 58 by tapping the OK button 70, thereby returning to main screen 36 shown in FIG. 2. As also shown in FIG. 6, a user or participant may add information regarding an event by tapping an Add Event link 72 and uploading information regarding an event to server 16 in the manner described above.

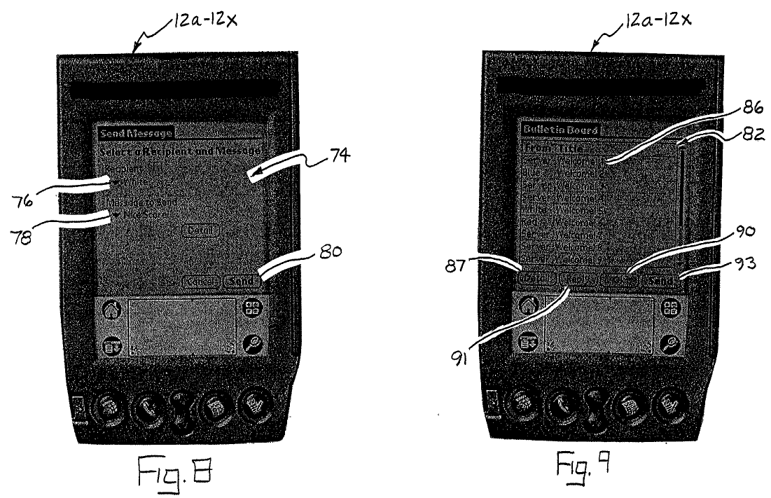

An additional feature provided by the system of the present invention is a bulletin board feature wherein participants or other authorized users may send and receive messages by posting and reading messages on a bulletin board maintained by server 16. For example, a participant may send a message to another participant by activating the message icon 72 shown in FIG. 3, causing application software 28 to generate a message screen 74 as shown in FIG. 8. By tapping the recipient arrow 76, the participant may select a recipient (e.g., an individual participant, a team, or all participants of an event). Upon tapping the message arrow 78, the participant is presented with a list of predefined messages such as “nice shot” or “good putt.” The participant may select the desired message and tap the send button 80 to cause wireless device 12a-12x to transmit the message to transceiver 13, network 14, and server 16. The message may be date and time-stamped at this time. Server software 30 posts the selected message on a bulletin board screen 82 such as that shown in FIG. 9, and associates the message with the selected recipient. Server software 30 may also be configured to provide an indication (such as, for example, a pop-up message) to the intended recipient indicating that a message for the recipient has been posted on bulletin board screen 82. Server software 30 enables server 16 to transmit this message indicator via network 14 and transceiver 13 to the wireless device 12a-12x of the intended recipient. Alternatively, the content of the entire message may be transmitted to the recipient as a pop-up message, depending upon the message preferences set by the recipient upon configuring the operation of application software 28.

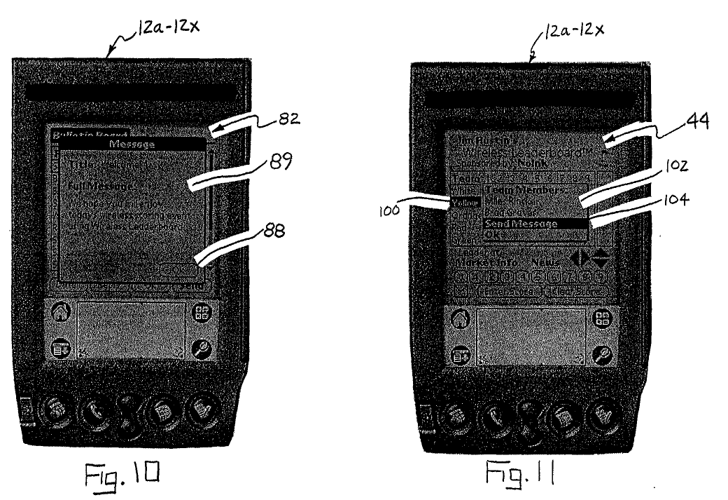

A participant may view bulletin board screen 82 by selecting a “switch to bulletin board” option from an action pull-down menu provided by the operating system of wireless device 12a-12x. When bulletin board screen 82 is displayed as shown in FIG. 9, the participant may tap on a message 86 or highlight a message 86 and tap the Detail button 87 to view the detail or content screen of the message as shown in FIG. 10. The participant may back up to scoring screen 44 of FIG. 3 by tapping the OK buttons 88, 90 of screens 89, 82, respectively. The participant may reply to a posted message 86 from bulletin board screen 82 using Reply button 91. By tapping Reply button 91, the participant causes application software 28 to generate a screen (not shown) listing pre-defined responses. The participant may select a response and tap the Send button 93 to send the message in the manner described above.

Alternatively, as indicated by FIG. 11, a participant may tap a team name 100 on scoring screen 44 to bring up a pop-up menu 102 that displays the names of the members of the team and a Send Message option 104. By selecting send message option 104, the participant evokes message screen 74 (FIG. 8) that is used in the manner described above.

Director software 32, administrator software 34, and server software 30 may be configured such that the users of director browser interface 22, administrator device 24, and web user browser interface 26 may send messages in the manner described above to other users or participants connected to the system. Additionally, the system may be configured to permit custom messages as opposed to predefined messages. In this event, server software 30 may be configured to censor the messages to eliminate undesirable language by including a filter according to principles that are well-known in the art. Server software 30 may also include a message counter that permits transmission or posting of only a predetermined number of messages within a predetermined time to avoid harassment of participants.

The foregoing description of the invention is illustrative only, and is not intended to limit the scope of the invention to the precise terms set forth. Although the invention has been described in detail with reference to certain illustrative embodiments, variations and modifications exist within the scope and spirit of the invention as described and defined in the following claims.

What is claimed is:

1. A system for distributing information during an event among a plurality of participants of the event, the system including:
a plurality of wireless devices individually associated with the plurality of participants, each wireless device including application software for enabling an associated participant to periodically store individual information in the wireless device during the event;
a network including a transceiver adapted to wirelessly receive individual information from and provide event information to the wireless devices;
a server connected to the network, the server including server software to enable the server to receive individual information from the transceiver, compute the event information based on the received individual information, and transmit the event information to the transceiver for wireless distribution to the participants via the wireless devices;
wherein the application software continues to enable storage of individual information in a wireless device when the wireless device including the application software is outside a range of communication with the transceiver.

2. The system of claim 1 wherein the individual information is uploaded after a predetermined time period has elapsed.

3. The system of claim 1 wherein the wireless devices are personal digital assistants.

4. The system of claim 1 wherein the wireless devices include CDPD modems.

5. The system of claim 1 wherein the network includes the internet.

6. The system of claim 1 wherein the application software includes a web browser.

7. The system of claim 1 wherein the application software enables the participants to transmit messages to other participants.

8. The system of claim 7 wherein the messages are stored on the server.

9. The system of claim 7 wherein the server software includes a filter for censoring the messages.

10. The system of claim 7 wherein the server software prevents transmission of messages to a participant in excess of a predetermined number of messages within a predetermined period of time.

11. The system of claim 7 wherein the messages are displayed to recipients as pop-up messages.

12. The system of claim 1 wherein the server software maintains a calendar of events on a web site on the network.

13. The system of claim 1 wherein the server software permits web users access to the event information via a web site on the network.

14. The system of claim 1 wherein the server software permits web users access to a web site including the event information and a calendar of events without requiring the web users to log in to the web site.

15. The system of claim 1 wherein the server includes a database for storing the individual information and the event information.

16. The system of claim 1 wherein the server software forwards an e-mail message to a participant in the event including the participant's individual information.

17. The system of claim 1 wherein the event includes an activity relating to one of marketing research, voting, fishing, and golf.

18. The system of claim 1 wherein the server software enables on-line registration for events via a web site.

19. The system of claim 18 wherein the web site is commerce-enabled.

20. The system of claim 1 wherein the event is a golfing event and the individual information is golf score data of one of a participant and a team including the participant.

21. The system of claim 20 wherein the server software permits web users access via a web site to a handicapping system after the web users log in to the web site, the handicapping system permitting submission of golf score data and providing updated handicap information.

22. The system of claim 20 wherein the event information is a leaderboard including the golf score data of participants in the event in leader order.

23. The system of claim 20 wherein the server software stops providing event information to a participant if the participant fails to upload golf score data for one of a predetermined number of holes of golf and a predetermined time period.

24. The system of claim 20 wherein the golf score data is uploaded after a hole of golf is completed.

25. The system of claim 20 wherein the server software interfaces with a handicapping system to permit calculations of handicaps of participants.

26. The system of claim 25 wherein the server software generates a listing of the handicaps to be viewed on a web site.

27. The system of claim 25 wherein the server software provides an e-mail message to a participant who submitted golf score data for calculation of a handicap, the e-mail message including the calculated handicap of the participant.

28. The system of claim 20 wherein the application software enables the participants to upload to the server information relating to holes of golf identified as contest holes.

29. The system of claim 28 wherein the contest holes include one of a longest drive hole, a longest putt hole, a closest-to-the-pin hole, and a hole-in-one hole.

30. The system of claim 28 wherein the server software updates the contest hole information upon receipt of contest hole information from a participant, and provides the contest hole information for viewing by the participants.

31. The system of claim 28 wherein the server software sends compiled contest hole information based on the contest hole information received from participants to a wireless device of a participant as a pop-up message when the participant completes a hole preceding a contest hole.

32. The system of claim 20 wherein the application software enables the wireless devices to download and store advertising material from the network for viewing by the participants.

33. The system of claim 32 wherein the application software generates a main screen and individual hole screens on the wireless devices, a portion of the advertising material being displayed on the main screen, and another portion of the advertising material being displayed on the individual hole screens.

34. The system of claim 33 wherein each of the individual hole screens includes a unique portion of the advertising material.

35. The system of claim 33 wherein the main screen includes a link to a web site with financial content.

36. The system of claim 33 wherein the main screen includes a link to a web site with news content.

37. The system of claim 33 wherein the application software permits participants to enter an e-mail address into a wireless device for submission to the server to obtain additional information relating to an advertiser included in the advertising material.

38. The system of claim 33 wherein the application software enables the wireless devices to create icons relating to advertisers selected by the participants and included in the advertising material.

39. The system of claim 33 wherein the advertising material includes an episodic advertisement, the application software displaying the episodic advertisement on a wireless device in response to an episode.

40. The system of claim 39 wherein the episode is completion of a predetermined hole.

41. The system of claim 39 wherein the episode is completion of a predetermined number of holes.

42. A program for use with a communication system including a plurality of wireless devices for communicating with a transceiver when within a range of communication with the transceiver, the transceiver being coupled to a server by a network, the program including:
application software loaded on the wireless devices, the application software enabling participants of an event to use the wireless devices to input and store in the wireless devices individual information during the event regardless of whether the wireless devices are within the range of the transceiver, the application software uploading to the transceiver the individual information inputted into a wireless device when the wireless device is within the range of the transceiver; and
server software loaded on the server, the server software receiving the individual information from the transceiver and providing to the transceiver an updated compilation of the individual information from the participants as the individual information is received for substantially continuous distribution to wireless devices within the range of the transceiver.

43. The program of claim 42 wherein the individual information is uploaded after a predetermined time period has elapsed.

44. The program of claim 42 wherein the application software enables the participants to transmit messages to other participants.

45. The program of claim 42 wherein the server software maintains a calendar of events on a web site on the network.

46. The program of claim 42 wherein the server software forwards an email message to a participant in the event including the participant's individual information.

47. The program of claim 42 wherein the event is a golfing event, the individual information is golf score data of one of a participant and a team including the participant, and the event information is a leaderboard including the golf score data of participants in the event in leader order.

48. The program of claim 47 wherein the server software permits web users access via a web site to a handicapping system after the web users log in to the web site, the handicapping system permitting submission of golf score data and providing updated handicap information.

49. The program of claim 47 wherein the golf score data is uploaded after a hole of golf is completed.

50. The program of claim 47 wherein the application software enables the participants to upload to the server information relating to holes of golf identified as contest holes.

51. The program of claim 50 wherein the server software updates the contest hole information upon receipt of contest hole information from a participant, and provides the contest hole information for viewing by the participants.

52. The program of claim 47 wherein the application software enables the wireless devices to download and store advertising material from the network for viewing by the participants.

53. A method of providing a substantially continuously updated golf score leaderboard to participants in a golfing event, the method including the steps of:
enabling wireless devices carried by the participants to wirelessly communicate golf score data of the participants to a server via a transceiver coupled to the server by a network, the wireless devices communicating the golf score data only when within a range of communication with the transceiver;
enabling each wireless device to receive and store golf score data from a participant at any time during the event, regardless of whether the wireless device is within the range of the transceiver;
updating a leaderboard based on the golf score data of the participants when golf score data is received by the server; and
downloading the updated leaderboard to the wireless devices substantially continuously during the golfing event.

54. The method of claim 53 further including the step of providing the wireless devices to the participants.

55. The method of claim 53 wherein the golf score data is automatically communicated to the server after a predetermined time period has elapsed.

56. The method of claim 53 further including the step of providing a database connected to the server for storing the golf score data and the updated leaderboard.

57. The method of claim 53 further including the step of preventing the downloading of the updated leaderboard to a particular participant if the participant fails for a predetermined number of holes of golf to communicate golf score data.

58. The method of claim 53 wherein the golf score data is communicated after a hole of golf is completed.

59. A system for distributing scoring information and advertisements during an event among a plurality of participants in the event, the system including:
a plurality of wireless devices individually associated with the plurality of participants, each wireless device including application software for enabling an associated participant to periodically store individual information in the wireless device during the event;
a network including a transceiver adapted to receive individual information from and transmit information to the wireless devices; and
a server connected to the network, the server including server software to enable the server to receive individual information from the transceiver and transmit event information based on the received individual information to the transceiver for wireless distribution to the participants via the wireless devices;
wherein the application software further enables the wireless devices to download from the server resident advertising material and links to network advertising material, thereby permitting viewing of the resident advertising material on a wireless device that is out of a range of communication with the transceiver.

60. A program for use with a communication system including a plurality of wireless devices for communicating with a transceiver when within a range of communication with the transceiver, the transceiver being coupled to a server by a network, the program including:
application software loaded on the wireless devices, the application software enabling the wireless devices to upload during an event to the server via the transceiver individual information of participants in the event, and to download and store advertising material and links to network advertising material, the stored advertising material being viewable on a wireless device that is out of the range of the transceiver; and
server software loaded on the server, the server software receiving individual information from the transceiver and providing to the transceiver event information based on the individual information as the individual information is received for substantially continuous distribution to wireless devices within the range of the transceiver.

61. A method of providing a substantially continuously updated golf score leaderboard and continuously viewable advertising material to participants in a golfing event, the method including the steps of:
enabling wireless devices carried by the participants to wirelessly communicate golf score data of the participants to a server via a transceiver coupled to the server by a network;
enabling the wireless devices to download and store advertising material from the network for viewing by the participants even when the wireless devices are outside a range of communication with the transceiver;
updating a leaderboard based on the golf score data of the participants each time golf score data is received by the server; and
downloading the updated leaderboard to the wireless devices substantially continuously during the golfing event.
